(19) United States
(12) Patent Application Publication
(10) Pub. No.: US 2008/0008973 A1
(43) Pub. Date: Jan. 10, 2008

(54) SUBSTRATE PROCESSING METHOD AND SUBSTRATE PROCESSING APPARATUS

(76) Inventors: Tomohiro GOTO, Kyoto (JP); Masakazu SANADA, Kyoto (JP); Osamu TAMADA, Kyoto (JP)

Correspondence Address: OSTROLENK FABER GERB & SOFFEN, 1180 AVENUE OF THE AMERICAS, NEW YORK, NY, 100368403, US

(21) Appl. No.: 11/775,759

(22) Filed: Jul. 10, 2007

(30) Foreign Application Priority Data
Jul. 10, 2006 (JP) 2006-189361
Aug. 2, 2006 (JP) 2006-210424

(51) Int. Cl. G03D 5/04; G03C 5/305

(52) U.S. Cl. 430/432; 396/611

(57) ABSTRACT

The invention provides a method capable of preventing the occurrence of collapse of resist pattern accompanied by size reduction in pattern dimensions can be prevented when processing a resist film having been exposed and formed on the surface of a substrate, and in which there is no fear that posterior processes are adversely affected. In the step of processing a resist film having been exposed and formed on the surface of a substrate, a developer mixed with a hydrophobizing agent is fed onto the resist film on the substrate surface; or before rinsing the resist film having been processed, a solvent containing a hydrophobic resin is fed onto the resist film on the substrate surface. Thus, a resist exposed surface is made to be hydrophobic before the rinsing, and thereafter rinsed and dried by spinning.

### BACKGROUND OF THE INVENTION

1. Field of the Invention

The present invention relates to a substrate processing method in which a developer is fed onto a resist film having been exposed and formed on the surface of substrates such as semiconductor wafers, liquid crystal display glass substrates, photo-mask glass substrates, and optical disk substrates, to make a processing. The invention also relates to a substrate processing apparatus.

2. Description of the Related Art

It is a recently trend that in the manufacturing process of a semiconductor device, a higher integration has been advanced due to size reduction in pattern dimensions. An aspect ratio of a resist pattern comes to be higher as such size reduction in pattern dimensions is further going on, and as a result of this, a phenomenon of collapse of resist pattern in a development process has increasingly become a serious problem. In the phenomenon of collapse of a resist pattern formed on the surface of a substrate, it is known that there are some modes. As one mode, it is known that after development, when a de-ionized water (DI water) (rinsing liquid) is discharged onto a resist pattern to make rinsing and a substrate is rotated about a vertical axis to make a spin drying, in case where there remains any liquid such as developer or DI water in a gap between one pattern and another, a Laplace force of the liquid is exerted on a pattern, and thus the pattern comes to be collapsed.

In this respect, a stress σ to be exerted on a resist pattern due to Laplace force of the liquid is given in the following expression:

σ=[6γ(H/W)² cos θ]/D

where: γ is a surface tension of a liquid; H, W and D are the height of a pattern, the width of a pattern and the distance between one pattern and another respectively. θ is a contact angle between a resist and a liquid.

As is understood from the above expression, to make a stress σ exerted on a resist pattern smaller thereby preventing the collapse of the resist pattern, it is preferable that the surface tension γ of a liquid is made smaller. As improvement means based on such concept, it has been proposed to carry out rinsing with the use of a rinsing liquid in which a surfactant acting to decrease a surface tension is contained (refer to, for example, the Japanese Patent Publication (unexamined) No, 14844/2004). Alternatively, supposing that a contact angle θ between a resist and a liquid is controlled to be approximately 90°, the stress σ will be substantially zero, so that the collapse of resist pattern can be prevented.

However, in the case of rinsing with the use of a rinsing liquid containing a surfactant, the surfactant remains on the surface of a resist pattern, which adversely affects posterior processes. Moreover, when controlling the contact angle θ between resist and liquid to be approximately 90° before the development process, a developer will be hard to be evenly spread on the resist film in the development process.

### SUMMARY OF THE INVENTION

The present invention was made in view of the above-discussed problems, and has an object of providing a substrate processing method capable of preventing the occurrence of the collapse of resist pattern due to size reduction in pattern dimensions, and in which posterior processes are not adversely affected as is the case of rinsing with the use of a rinsing liquid containing a surfactant therein, and further there is no occurrence of a developer being less evenly spread on a resist film in a development process. Another object of the invention is to provide a substrate processing apparatus with which the mentioned method can be preferably carried out.

The invention as defined in claim 1 is a substrate processing method comprising: a development process in which a developer is fed onto a resist film having been exposed and formed on a surface of a substrate to process the resist film; a rinsing process in which a rinsing liquid is fed onto the resist film having been processed and formed on the substrate surface to make a rinsing; and a drying process in which the substrate is rotated about a vertical axis in a horizontal posture to dry the resist film having been rinsed and formed on the substrate surface; and in which before the mentioned rinsing process, a resist exposed surface is made to be hydrophobic.

According to this substrate processing method, before a rinsing liquid is fed onto a resist film in the rinsing process, a resist pattern surface (resist exposed surface) newly exposed by the development process is made to be hydrophobic. Then, due to that the resist pattern surface is made to be hydrophobic, a surface tension or a surface free energy of the resist pattern is decreased. Therefore, at the time of rinsing and spin-drying of the substrate, the adhesive energy of liquids such as developer or rinsing liquid to the resist pattern surface is reduced. As a result, even if there remains any liquid such as developers or DI water in a gap between one pattern and another, a Laplace force of the liquid to be exerted on the pattern is decreased, the collapse of resist pattern being prevented. In this case, a chemical composition itself in the resist film is not changed. Furthermore, it is not difficult to evenly spread the developer on the resist film in the development process.

Consequently, according to this substrate processing method, while keeping various characteristics of a resist film, the collapse of resist pattern due to size reduction in pattern dimensions can be successfully prevented, there is no fear that posterior processes are adversely affected being different from the case of rinsing with the use of a rinsing liquid containing a surfactant therein, and further there is no occurrence of the developer being less evenly spread on the resist film.

The invention as defined in claim 2 is the substrate processing method according to claim 1, and in which in the mentioned development process, a developer mixed with a hydrophobizing agent is fed onto the resist film on the substrate surface.

According to this substrate processing method, due to that a developer to be fed onto a resist film on the substrate surface is mixed with a hydrophobizing agent, before a rinsing liquid is fed onto the resist film in the rinsing process, a resist pattern surface newly exposed by the development process is made to be hydrophobic by the hydrophobizing agent. In this case, the property on the surface of a resist film is just changed, and a chemical composition itself in the resist film is not changed. Furthermore, a hydrophobizing agent is removed from the substrate by rinsing of the substrate or evaporated at the time of spin drying, or when it is fed onto the resist film in a steam state, no hydrophobizing agent remains on the substrate.

The invention as defined in claim 3 is the substrate processing method according to claim 1, and in which after the mentioned development process, before the mentioned rinsing process, a hydrophobizing agent is fed onto the resist film formed on the substrate surface.

The invention as defined in claim 4 is the substrate processing method according to claim 1, and in which after the mentioned development process, before the mentioned rinsing process, a rinsing liquid is fed onto the resist film formed on the substrate surface to make a preliminary rinsing, and thereafter, a hydrophobizing agent is fed onto the resist film.

According to these substrate processing methods, due to that after the development process, before the rinsing process, a hydrophobizing agent is fed onto the resist film on the substrate surface, whereby before a rinsing liquid is fed onto the resist film in the rinsing process, a resist pattern surface newly exposed by the development process is made to be hydrophobic.

The invention as defined in claim 5 is the substrate processing method according to claim 3 or 4, and in which the mentioned hydrophobizing agent is fed onto the resist film as a hydrophobic solution containing a hydrophobizing agent.

According to this substrate processing method, due to that a hydrophobizing agent contained in the hydrophobic solution is fed onto the resist film on the substrate surface, a resist pattern surface newly exposed by the development process is made to be hydrophobic.

The invention as defined in claim 6 is the substrate processing method according to claim 5, and in which a surfactant is added to the mentioned hydrophobic solution.

In this substrate processing method, due to that a surfactant is added, the hydrophobizing agent is uniformly mixed with a solvent or water.

The invention as defined in claim 7 is the substrate processing method according to claim 5, and in which the mentioned hydrophobic solution is prepared by adding a surfactant to a hydrophobizing agent of which specific gravity is large as compared with the developer.

According to this substrate processing method, in the case where a hydrophobic solution containing a hydrophobizing agent is fed onto a resist film on a substrate surface after a development process, when a developer is mixed with the hydrophobic solution and thereafter a liquid mixture is divided into two layers, due to that the hydrophobic solution containing the hydrophobizing agent is laid on the lower layer side, the hydrophobizing agent comes reliably in contact with a resist pattern surface newly exposed by the development process.

The invention as defined in claim 8 is the substrate processing method according to claim 3 or 4, and in which the mentioned hydrophobizing agent is fed onto the resist film in a steam state.

According to this substrate processing method, due to that a hydrophobizing agent comes in contact with the surface of the resist film in a steam state, a resist patter surface newly exposed by the development process is made to be hydrophobic.

The invention as defined in claim 9 is the substrate processing method according to any one of claims 2 through 4, and in which dimethyldichlorosilane, hexamethyldisilazane or a perfluoro compound is used as the mentioned hydrophobizing agent.

According to this substrate processing method, due to that dimethyldichlorosilane, HMDS or a perfluoro compound comes in contact with the surface of the resist film, a resist pattern surface newly exposed by the development process is made to be hydrophobic.

The invention as defined in claim 10 is the substrate processing method according to claim 1, and in which after the mentioned development process, before the mentioned rinsing process, a solvent containing a hydrophobic resin is fed onto the resist film having been processed and formed on the substrate surface, and thus the resist exposed surface is coated with a hydrophobic resin film.

According to this substrate processing method, due to that after the development process, before a rinsing process, a solvent containing a hydrophobic resin is fed onto the resist film on the substrate surface, and thus a resist pattern surface (resist exposed surface) newly exposed by the development process is coated with a hydrophobic resin film, a rinsing liquid comes in contact with the resist exposed surface via the hydrophobic resin film at the time of rinsing and spin drying of the substrate. In this way, the rinsing liquid comes directly in contact with a hydrophobic resin film, so that a contact angle between a resist pattern and a rinsing liquid becomes approximately 90°. Therefore, when the substrate is rotated about a vertical axis to be dried by spinning after the rinsing, even if there remains a rinsing liquid in a gap between one pattern and another, the stress a to be exerted on a resist pattern due to the Laplace force of the rinsing liquid is decreased, so that the collapse of resist paten is prevented. In this case, the surface of the resist film is just coated with a hydrophobic resin film, and a chemical composition of the resist film itself is not changed. Furthermore, the solvent containing a hydrophobic resin is removed from the substrate by rinsing of the substrate, or evaporated at the time of spin-drying, so that it does not remain on the substrate. In addition, a hydrophobic resin film is formed on the surface of the resist film after the development process, so that it is not difficult to evenly spread a developer on the resist film in the development process.

The invention as defined in claim 11 is the substrate processing method according to claim 1, and in which in the mentioned development process, a developer mixed with a solvent containing a hydrophobic resin is fed onto the resist film having been exposed and formed on the substrate surface, and thus the resist exposed surface is coated with a hydrophobic resin film.

According to this substrate processing method, in the development process, a developer mixed with a solvent containing a hydrophobic resin is fed onto the resist film on the substrate surface, and thus a resist pattern surface (resist exposed surface) newly exposed by the development process is coated with a hydrophobic resin film. As a result, the same advantages as those of the invention as defined in claim 10 are achieved. Furthermore, before the development process, no hydrophobic resin film is formed on the surface of a resist film, so that it is not difficult to evenly spread the developer on the resist film in the development process.

The invention as defined in claim 12 is the substrate processing method according to claim 10 or 11, and in which as a solvent containing the mentioned hydrophobic resin, the one of which specific gravity is large as compared with a developer is used.

According to this substrate processing method, in the case where a solvent containing a hydrophobic resin is fed onto the resist film onto the substrate surface after the development process, when a developer is mixed with a solvent containing a hydrophobic resin and thereafter a liquid mixture is divided into two layers; or in the case where a developer mixed with a solvent containing a hydrophobic resin is fed onto the resist film on the substrate surface in the development process, when a liquid mixture of the developer and the solvent containing a hydrophobic resin is divided into two layers, a solvent containing the hydrophobic resin is laid on the lower layer side. Consequently, the solvent containing a hydrophobic resin comes reliably in contact with a resist pattern surface newly exposed by the development process, and thus a hydrophobic resin film is formed on the resist pattern surface.

The invention as defined in claim 13 is the substrate processing method according to claim 1, and in which after the mentioned development process, before the mentioned rinsing process, a rinsing liquid is fed onto the resist film having been processed and formed on the substrate surface to make a preliminary rinsing, thereafter a solvent containing a hydrophobic resin is fed onto the resist film, and thus the resist exposed surface is coated with a hydrophobic resin film.

According to this substrate processing method, after a development process, before a rinsing process, a solvent containing a hydrophobic resin is fed onto a resist film on a substrate surface after the substrate has been preliminarily rinsed, and thus a resist pattern surface (resist exposed surface) newly exposed by the development process is coated with a hydrophobic resin film. As a result, the same advantages as those of the invention as defined in claim 10 are brought about. In addition, the hydrophobic resin film is formed on the surface of a resist film after the preliminary rinsing, not after the development process, so that it is not difficult to evenly spread the developer on the resist film in the development process.

The invention as defined in claim 14 is the substrate processing method according to claim 1, and in which before the mentioned rinsing process, there is included a cleaning process in which a cleaning solution is fed onto the resist film having a predetermined pattern that is formed on the surface of a substrate to make a cleaning of the resist film; and in the mentioned rinsing process, a rinsing liquid is fed onto the resist film having been cleaned to make a rinsing; and after the mentioned cleaning process, before the mentioned rinsing process, a rinsing liquid is fed onto the resist film having been cleaned and formed on the substrate surf ace to make a preliminary rinsing, thereafter a solvent containing a hydrophobic resin is fed onto the resist film, and thus the resist exposed surface is coated with a hydrophobic resin film.

According to this substrate processing method, after a cleaning process, before a rinsing process, a solvent containing a hydrophobic resin is fed onto a resist film on a substrate surface after the substrate has been preliminarily rinsed, and thus the resist pattern surface (resist exposed surface) is coated with a hydrophobic resin film. Consequently, the same advantages as those of the invention as defined in claim 10 are achieved.

The invention as defined in claim 15 is the substrate processing method according to claim 13 or 14, and in which as a solvent containing the mentioned hydrophobic resin, the one of which specific gravity is large as compared with a rinsing liquid is used.

According to this substrate processing method, in the case where a solvent containing a hydrophobic resin is fed onto a resist film on a substrate surface after the preliminary rinsing, a rinsing liquid is mixed with a solvent containing a hydrophobic resin and thereafter a liquid mixture is divided into two layers, due to that the solvent containing a hydrophobic resin is laid on the lower layer side, the solvent containing a hydrophobic resin agent comes reliably in contact with a resist pattern surface, and the hydrophobic resin film is formed on the resist pattern surface.

The invention as defined in claim 16 is the substrate processing method according to claim 10 or 11, or claim 13 or 14, and in which as a solvent containing the mentioned hydrophobic resin, the one that is water insoluble is used.

According to this substrate processing method, a solvent containing a hydrophobic resin and a developer, or a cleaning solution or a rinsing liquid are not dissolved in each other, and a solvent containing a hydrophobic resin and a developer, or a cleaning solution or a rinsing liquid are separated in layers. Thus in a state that a hydrophobic resin is contained in a solvent layer at a high concentration, a hydrophobic resin comes in contact with a resist pattern surface, and a hydrophobic resin film is formed on the resist pattern surface.

The invention as defined in claim 17 is the substrate processing method according to claim 10 or 11, or claim 13 or 14, and in which as the mentioned hydrophobic resin, the one that makes a contact angle of 70° to 110° between the hydrophobic resin film and the rinsing liquid is used.

According to this substrate processing method, the stress to be exerted on a resist pattern due to Laplace force of the rinsing liquid can be reliably reduced.

The invention as defined in claim 18 is the substrate processing method according to claim 10 or 11, or claim 13 or 14, and in which the mentioned hydrophobic resin is a fluorine-based resin or a silicone-based resin.

According to this substrate processing method, due to that the resist pattern surface is coated with a hydrophobic fluorine-based resin film or silicone-based resin film, a contact angle between the resist pattern and the rinsing liquid is approximately 90°, and the stress to be exerted on the resist pattern due to Laplace force of the rinsing liquid can be reliably reduced.

The invention as defined in claim 19 is the substrate processing method according to claim 10 or 11, or claim 13 or 14, and in which in the mentioned drying process, the substrate is held in a horizontal posture and rotated about a vertical axis; and while a rinsing liquid is being discharged onto the surface of the substrate from an outlet of a discharge nozzle, the mentioned outlet of the discharge nozzle is scanned from a position opposed to the center of the substrate to a position opposed to the circumferential edge of the substrate.

According to this substrate processing method, when the substrate is spin-dried by scan rinsing, it is possible to prevent the substrate from being adhered by mist which may result in the occurrence of a failure of development.

The invention as defined in claim 20 is a substrate processing apparatus comprising: substrate holding means holding a substrate in a horizontal posture; a developer discharge nozzle discharging a developer on a resist film having been exposed and formed on a surface of the substrate held by the mentioned substrate holding means; developer feeding means feeding a developer to the mentioned developer discharge nozzle; a rinsing liquid discharge nozzle discharging a rinsing liquid onto a resist film having been processed and formed on the substrate surface; rinsing liquid feeding means feeding a rinsing liquid to the mentioned rinsing liquid discharge nozzle; and substrate rotating means rotating the substrate held by the mentioned substrate holding means about a vertical axis; and in which there is provided means for making hydrophobic a resist exposed surface of the resist film that is formed on the surface of the substrate before rinsing.

When using this substrate processing apparatus, the substrate processing method as defined in claim 1 can be preferably carried out, and the above-mentioned advantages are achieved.

The invention as defined in claim 21 is the substrate processing apparatus according to claim 20, and in which the mentioned developer feeding means feeds a developer mixed with a hydrophobizing agent to the mentioned developer discharge nozzle.

According to this substrate processing apparatus, due to that a developer, which is fed to the developer discharge nozzle by the developer feeding means and discharged onto a resist film on the substrate surface from the developer discharge nozzle, is mixed with a hydrophobizing agent, before a rinsing liquid is discharged onto the resist film from the rinsing liquid discharge nozzle, a resist pattern surface newly exposed by the development process is made to be hydrophobic with the hydrophobizing agent. Consequently, when using this substrate processing apparatus, the substrate processing method as defined in claim 2 can be preferably carried out, and the above-mentioned advantages can be achieved.

The invention as defined in claim 22 is the substrate processing apparatus according to claim 20, and in which there are further provided a solution discharge nozzle discharging a hydrophobic solution containing a hydrophobizing agent onto the resist film having been processed and formed on the substrate surface; and solution feeding means feeding the hydrophobic solution containing a hydrophobizing agent to the mentioned solution discharge nozzle.

According to this substrate processing apparatus, due to that a hydrophobic solution containing a hydrophobizing agent having be fed to the solution discharge nozzle by solution feeding means is discharged onto the resist film on a substrate surface from the solution discharge nozzle, before a rinsing liquid is discharged onto the resist film from the rinsing liquid discharge nozzle, a resist pattern surface newly exposed by the development process is made to be hydrophobic. Consequently, when using this substrate processing apparatus, the substrate processing method as defined in claim 3 or 5 can be preferably carried out, and the above-mentioned advantages can be achieved.

The invention as defined in claim 23 is the substrate processing apparatus according to claim 20, and in which there are further provided a steam jet nozzle blowing out a steam of a hydrophobizing agent onto the resist film having been processed and formed on the substrate surface; and steam feeding means feeding a steam of a hydrophobizing agent to this steam jet nozzle.

According to this substrate processing apparatus, due to that a steam of a hydrophobizing agent having been fed to the steam jet nozzle by the steam feeding means is discharged onto the resist film on a substrate surface from the steam jet nozzle to come in contact with the resist film surface, before a rinsing liquid is discharged onto the resist film from the rinsing liquid discharge nozzle, a resist pattern surface newly exposed by the development process is made to be hydrophobic. Consequently, when using this substrate processing apparatus, the substrate processing method as defined in claim 8 can be preferably carried out.

The invention as defined in claim 24 is the substrate processing apparatus according to any one of claims 21 through 23, and in which the mentioned developer discharge nozzle is a slit nozzle that includes a slit-like outlet at a lower end face, the developer is discharged onto the resist film on the substrate surface from the mentioned slit-like outlet, while linearly moving in a direction orthogonal to the mentioned slit-like outlet with respect to a substrate held in a still state by the mentioned substrate holding means, and thus the developer is spread forming a continuous film on the entire surface of the resist film.

According to this substrate processing apparatus, due to that while the slit nozzle is moving with respect to the substrate held in a still state by the substrate holding means, a developer is discharged onto the resist film on the substrate surface from a slit-like outlet of the slit nozzle, and thus a developer is spread forming a continuous film on the entire surface of the resist film and the resist film is processed.

The invention as defined in claim 25 is the substrate processing apparatus according to any one of claims 21 through 23, and in which the mentioned developer discharge nozzle is a straight nozzle in which the developer is discharged from a tip end outlet to a center of the substrate that is held by the mentioned substrate holding means and rotated at a low speed by the mentioned substrate rotating means, and thus the developer is spread on the entire surface of the resist film on the substrate surface to apply the developer.

In this substrate processing apparatus, due to that a developer is discharged from a tip end outlet to the center of a substrate that is held by substrate holding means and rotated at a low speed by the substrate rotating means, and thus the developer is spread on the entire surface of the resist film on the substrate surface to be applied and the resist film is processed.

The invention as defined in claim 26 is the substrate processing apparatus according to claim 20, and in which there are further provided solvent discharge means discharging a solvent containing a hydrophobic resin on the resist film having been processed and formed on the substrate surface; and solvent feeding means feeding the solvent containing a hydrophobic resin to the solvent discharge means.

According to this substrate processing apparatus, due to that a solvent containing a hydrophobic resin is fed to solvent discharge means by the solvent feeding means and the solvent containing a hydrophobic resin is discharged onto a resist film on a substrate surface from solvent discharge means, before a rinsing liquid is discharged onto the resist film from the rinsing liquid discharge nozzle, a hydrophobic resin film is formed on the resist pattern surface newly exposed by the development process. Consequently, when using this substrate processing apparatus, the substrate processing method as defined in claims 10 and 13 can be preferably carried out, and the above-mentioned advantages can be achieved.

The invention as defined in claim 27 is the substrate processing apparatus according to claim 20, and in which the mentioned developer feeding means feeds to the mentioned developer discharge nozzle a developer mixed with a solvent containing a hydrophobic resin.

According to this substrate processing apparatus, due to that a developer, which is fed to the developer discharge nozzle by the developer feeding means and discharged onto the resist film on the substrate surface from the developer discharge nozzle, is mixed with a solvent containing a hydrophobic resin, before a rinsing liquid is discharged onto the resist film from the rinsing liquid discharge nozzle, a hydrophobic resin film is formed on a resist pattern surface newly exposed by the development process. Consequently, when using this substrate processing apparatus, the substrate processing method as defined in claim 11 can be preferably carried out, and the above-mentioned advantages can be achieved.

The invention as defined in claim 28 is the substrate processing apparatus according to claim 26 or 27, and in which the mentioned developer discharge nozzle is a slit nozzle that includes a slit-like outlet at a lower end face, the developer is discharged onto a resist film on the substrate surface from the mentioned slit-like outlet, while linearly moving in a direction orthogonal to the mentioned slit-like outlet with respect to a substrate held in a still state by the mentioned substrate holding means, and thus the developer is spread forming a continuous film on the entire surface of the resist film.

According to this substrate processing apparatus, due to that while a slit nozzle is moving with respect to a substrate held in a still state by the substrate holding means, a developer is discharged onto a resist film on the substrate surface from a slit-like outlet of this slit nozzle, and thus a developer is spread forming a continuous film on the entire surface of the resist film and the resist film is processed.

The invention as defined in claim 29 is the substrate processing apparatus according to claim 26 or 27, and in which the mentioned developer discharge nozzle is a straight nozzle in which the developer is discharged from a tip end outlet to a center of the substrate that is held by the mentioned substrate holding means and rotated at a low speed by the mentioned substrate rotating means, and thus the developer is spread on the entire surface of the resist film on the substrate surface to apply the developer.

According to this substrate processing apparatus, due to that a developer is discharged from the tip end outlet to the center of a substrate that is held by substrate holding means and rotated at a low speed by substrate rotating means, the developer is spread on the entire surface of the resist film on the substrate surface to be applied, and thus the resist film is processed.

The invention as defined in claim 30 is the substrate processing apparatus according to claim 20, and in which there are further provided a cleaning solution discharge nozzle discharging a cleaning solution on the resist film having a predetermined pattern that is formed on the surface of the substrate held by the mentioned substrate holding means; cleaning solution feeding means feeding a cleaning solution to the mentioned cleaning solution discharge nozzle; solvent discharge means discharging a solvent containing a hydrophobizing agent on the resist film having been cleaned and formed on the substrate surface; and solvent feeding means feeding a solvent containing a hydrophobic resin to the solvent discharge means.

According to this substrate processing apparatus, due to that a solvent containing a hydrophobic resin is fed to the solvent discharge means by the solvent feeding means, and the solvent containing a hydrophobic resin is discharged onto the resist film on the substrate surface from the solvent discharge means, before a rinsing liquid is discharged onto the resist film from the rinsing liquid discharge nozzle, a hydrophobic resin film is formed on a resist pattern surface. Consequently, when using this substrate processing apparatus, the substrate processing method as defined in claim 14 can be preferably carried out, and the above-mentioned advantages can be achieved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic plan view illustrating an example of construction of a processing apparatus for use in carrying out a method of processing a substrate, being a substrate processing method according to the present invention.

FIG. 2 is a sectional view taken along the line II-II of FIG. 1.

FIG. 3 is a sectional view taken along the line III-III of FIG. 1.

FIG. 4 is a schematic view illustrating a developer supply system of the substrate processing apparatus illustrated in FIG. 1.

FIGS. 5 (a) to (f) are schematic views each for explaining an example of processing operations of the substrate processing apparatus illustrated in FIGS. 1 through 4.

FIG. 6 is a partially enlarged sectional view illustrating a state that the surface of a resist pattern newly exposed by the development process is made to be hydrophobic with a hydrophobizing agent mixed with a developer.

FIG. 7 is a schematic plan view illustrating another example of construction of a substrate processing apparatus for use in carrying out a substrate processing method according to the invention.

FIGS. 8 (a) to (h) are schematic diagrams each for explaining an example of processing operations with the substrate processing apparatus illustrated in FIG. 7.

FIG. 9 is a schematic plan view illustrating a further example of construction of a substrate processing apparatus for use in carrying out a substrate processing method according to the invention.

FIG. 10 is a schematic longitudinal sectional view of the substrate processing apparatus illustrated in FIG. 9.

FIG. 11 is a schematic plan view illustrating a still further example of construction of a processing apparatus for use in carrying out a processing method of a substrate, being a substrate processing method according to the invention.

FIG. 12 is a sectional view taken along the line XII-XII of FIG. 11.

FIG. 13 is a sectional view taken along the line XIII-XIII of FIG. 11.

FIGS. 14 (a) to (h) are schematic views each for explaining one example of processing operations with a processing apparatus illustrated in FIGS. 11 through 13.

FIG. 15 is a partially enlarged sectional view illustrating a state that the surface of a resist pattern newly exposed by the development process is coated with a hydrophobic resin film.

FIGS. 16 (a) to (i) are schematic diagrams each for explaining another example of processing operations with the processing apparatus illustrated in FIGS. 11 through 13.

FIG. 17 is a schematic plan view illustrating a yet further example of construction of a processing apparatus for use in carrying out a processing method, being a substrate processing method according to this invention.

FIG. 18 is a schematic diagram illustrating a developer supply system of the processing apparatus illustrated in FIG. 17.

FIG. 19 are schematic diagrams for explaining an example of processing operations with the processing apparatus illustrated in FIG. 17.

### DESCRIPTION OF THE PREFERRED EMBODIMENTS

Several preferred embodiments according to the present invention are hereinafter described with reference to the accompanying drawings.

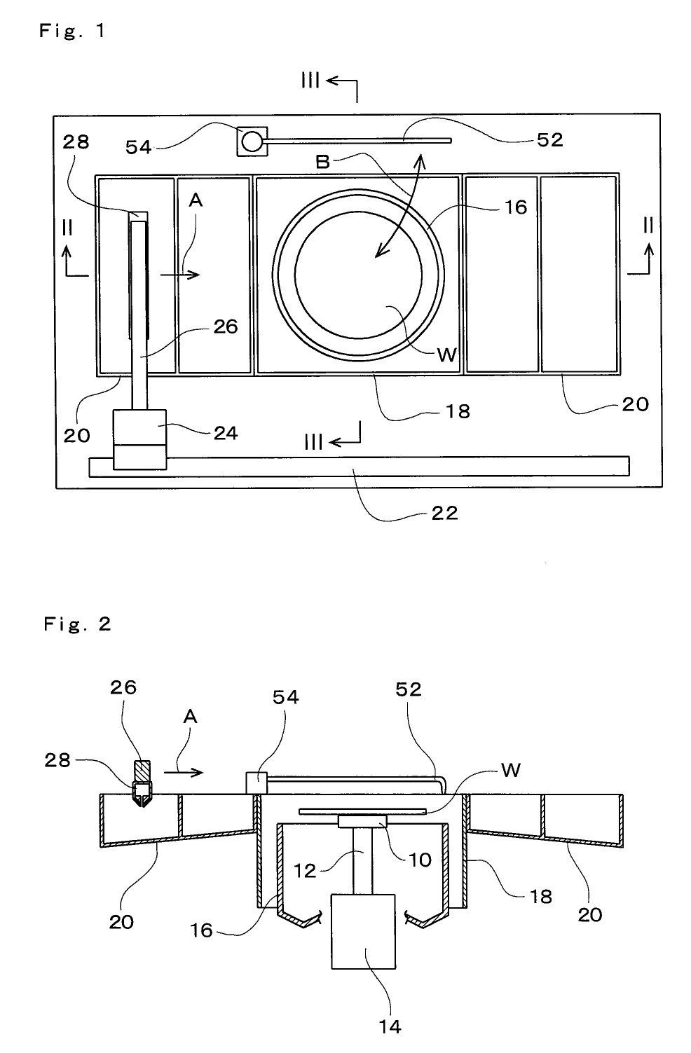

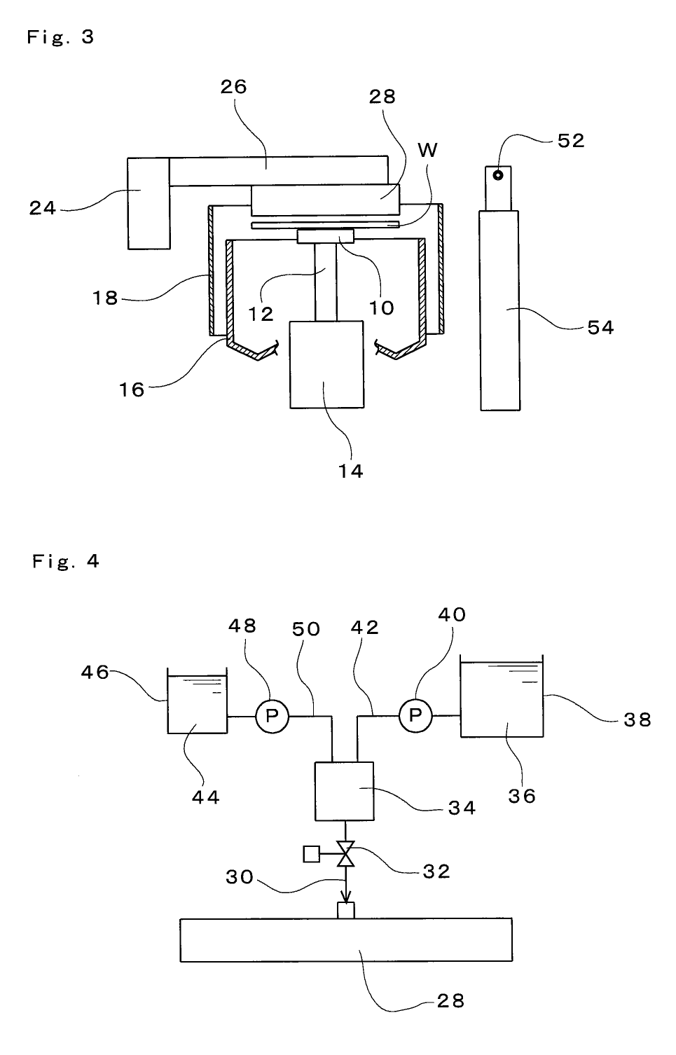

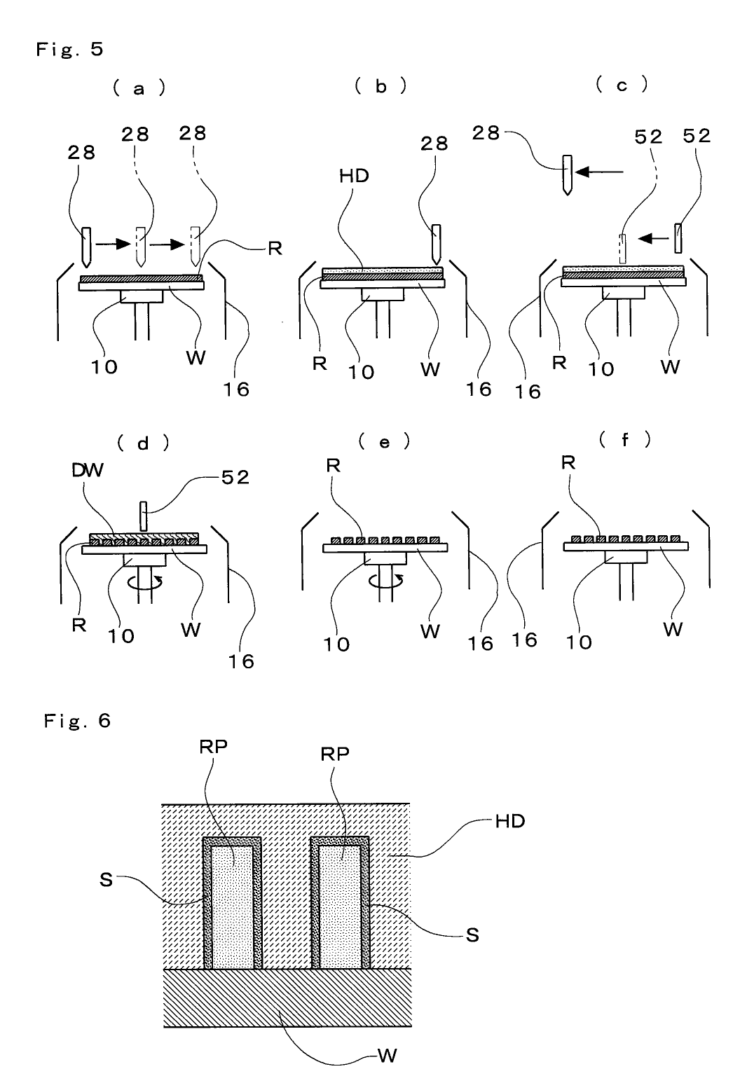

FIGS. 1 to 4 illustrate an example of construction of a processing apparatus for use in carrying out a method of processing a substrate, being a substrate processing method according to the invention. FIG. 1 is a plan view illustrating a schematic construction of the processing apparatus. FIG. 2 is a sectional view taken along the line II-II of FIG. 1, FIG. 3 is a sectional view taken along the line III-III of FIG. 1, and FIG. 4 is a schematic diagram illustrating a developer supply system of the processing apparatus.

This processing apparatus, at an apparatus center where processing of a substrate W is conducted, is provided with: a spin chuck 10 holding a substrate W in a horizontal posture; a rotary shaft 12 to which upper end the spin chuck 10 is fixed and which is vertically supported; and a rotation motor 14 of which rotary shaft is connected to the rotary shaft 12 and which causes the spin chuck 10 and the rotary shaft 12 to rotate about a vertical axis. An inside cup 16 of a circular shape is disposed around the spin chuck 10 so as to surround the substrate W on the spin chuck 10. This inside cup 16 is supported in a reciprocally movable manner in a vertical direction by a support mechanism, not illustrated. An outside cup 18 of a rectangular shape is disposed around the inside cup 16.

On both right and left sides of the outside cup 18, stand-by pots 20, 20 are disposed respectively. On one side portion of the outside cup 18 and the stand-by pot 20, a guide rail 22 is disposed in parallel with a direction of the outside cup 18 and the stand-by pot 20 being connected. An arm-driving portion 24 is engaged in a sliding manner with the guide rail 22, and holds a nozzle arm 26. A developer discharge nozzle 28 is attached by suspending from the nozzle arm 26 in a horizontal posture. The developer discharge nozzle 28, although a detailed illustration of a structure is omitted, includes a slit-like outlet longitudinally extending at a lower end face. This developer discharge nozzle 28 is disposed in a direction orthogonal to the guide rail 22. Further, it is constructed such that by means of the arm driving portion 24, the nozzle arm 26 is linearly reciprocated in a horizontal direction along the guide rail 22, and thus the developer discharge nozzle 28 can be scanned in a direction indicated by the arrow A and can be returned in a direction opposite thereto.

To the developer discharge nozzle 28, a developer feed tube 30 is communicated, and a switching control valve 32 is interposed in the developer feed tube 30. The developer feed tube 30 is communicated to a liquid mixer 34. Communicated to the liquid mixer 34 is a developer feed pipe 42, which is channel-connected to a developer reservoir 38 containing a developer 36 therein and in which a pump 40 is interposed. In addition, communicated to the liquid mixer 34 is a solution feed pipe 50, which is channel-connected to a solution reservoir 46 containing a hydrophobic solution 44 containing a hydrophobizing agent therein, and in which a pump 48 is interposed. Further, it is constructed such that a developer to be fed from the developer reservoir 38, through the developer feed pipe line 42, to the liquid mixer 34, is mixed with a hydrophobic solution containing a hydrophobizing agent to be fed from the solution reservoir 46, through the solution feed pipe line 50, to the liquid mixer 34. Then the developer mixed with the hydrophobizing agent is fed from the liquid mixer 34, through the developer feed tube 30, to the developer discharge nozzle 28. As a hydrophobizing agent, any agent can be employed insofar as it can control a surface energy of a resist film, as well as can keep various characteristics of a resist without causing any damage to the resist film. For example, dimethyldichlorosilane, HMDs or a perfluoro compound such as perfluoroalkylether, or an admixture thereof is used. A hydrophobic solution is prepared by adding a hydrophobizing agent to a suitable solvent such as xylene or water. In this case, to uniformly mix a hydrophobizing agent with a solvent or water, it is preferable that a small amount of a surfactant is added. The reason of use of a perfluoro compound having a larger specific gravity than that of a developer as a hydrophobizing agent or one component thereof is that when a developer mixed with a hyrophobing agent is fed onto a substrate W to be evenly spread on a resist film, a hydrophobic solution containing a hydrophobizing agent and a developer are separated in two layers, and the hydrophobic solution containing a hydrophobizing agent comes on a lower layer side, thereby allowing the hydrophobizing agent to come reliably in contact with the surface of a resist pattern.

Furthermore, in the rear-side vicinity of the outside cup 18, disposed is a DI water discharge nozzle 52 discharging onto the substrate W a rinsing liquid, for example, DI water from an outlet located at a tip end. The DI water discharge nozzle 52 is channel-connected to a DI water supply source through a DI water feed pipe, not illustrated. The DI water discharge nozzle 52 is held by a nozzle holding portion 54 pivotally within a horizontal plane in directions indicated by the arrows B, and is constructed so as to reciprocate between a stand-by position illustrated in FIG. 1 and a discharge position where the outlet at the tip end is located right over the central of a substrate W. This DI water discharge nozzle 52 discharges a DI water on the center of the substrate W.

Now, one example of a processing operation with a processing apparatus having the above-mentioned construction is described referring to schematic diagrams illustrated in FIG. 5.

As illustrated in FIG. 5(a), when a substrate W on which surface a resist film R having been exposed is formed is carried into the apparatus and the substrate W is held by the spin chuck 10, then as illustrated in FIG. 5(b), while a developer HD mixed with a hydrophobizing agent is being discharged from a slit-like outlet of the developer discharge nozzle 28, the developer discharge nozzle 28 is scanned in a direction indicated by the arrow A (refer to FIGS. 1 and 2) by means of the arm driving portion 24. In this manner, the developer HD is fed onto the substrate W to be evenly spread. When the developer discharge nozzle 28 is moved to a position of the stand-by pot 20 on the right side, the discharge of the developer is stopped, the developer discharge nozzle 28 is moved in a direction opposite to the direction indicated by the arrow A by means of the arm driving portion 24, and the developer discharge nozzle 28 is returned to the original position of the stand-by pot 20 on the left side. The substrate W is left still until a predetermined time period has elapsed since the developer HD being evenly spread over the substrate W, and then the resist film R on the surface of the substrate W is processed. At this time, the developer HD having been fed onto the substrate W is mixed with a hydrophobizing agent, so that as is illustrated in a partially enlarged sectional diagram of FIG. 6, a surface S of a resist pattern RP newly exposed by the development process is made to be hydrophobic with a hydrophobizing agent.

When a predetermined time period has elapsed since the liquid being evenly spread over a substrate W, the DI water discharge nozzle 52 is turned as illustrated in FIG. 5(c), a tip end outlet of the DI water discharge nozzle 52 is made to move to the position right over the center of the substrate W as illustrated in FIG. 5(d), and a DI water DW is discharged from the tip end outlet of the DI water discharge nozzle 52 to the center of the substrate W. At this time, it is also preferable that the substrate W is rotated at a low speed. Thus, the developing reaction of the resist film R on the surface of the substrate W is stopped, and the developer or dissolved substances are washed away with a DI water DW from the resist film R. When the discharge of the DI water is ended, the DI water discharge nozzle 52 is turned and returned to the original position illustrated in FIG. 1. Furthermore, after the discharge of the DI water, as illustrated in FIG. 5(e), the substrate W is rotated, whereby the DI water is splashed away from the substrate W by a centrifugal force to be removed, and the substrate W is dried by spinning. During this operation, the inside cup 16 is kept to be elevated. At the time of these rinsing and spin drying, the surface S of the resist pattern RP is made to be hydrophobic, and thus a surface tension or a surface free energy of the resist pattern RP is lowered, so that an energy of liquid being adhered to the surface S of the resist pattern RP is decreased (refer to FIG. 6). Therefore, even if there remains any liquid such as developer or DI water in a gap between one pattern RP and another pattern RP, a Laplace force of the liquid to be exerted on the pattern RP is reduced, and thus the collapse of the resist pattern RP is prevented. When the drying of the substrate W is ended, as illustrated in FIG. 5(f), the rotation of the substrate W is stopped, and the substrate W is removed from the spin chuck 10 to be carried out of the apparatus.

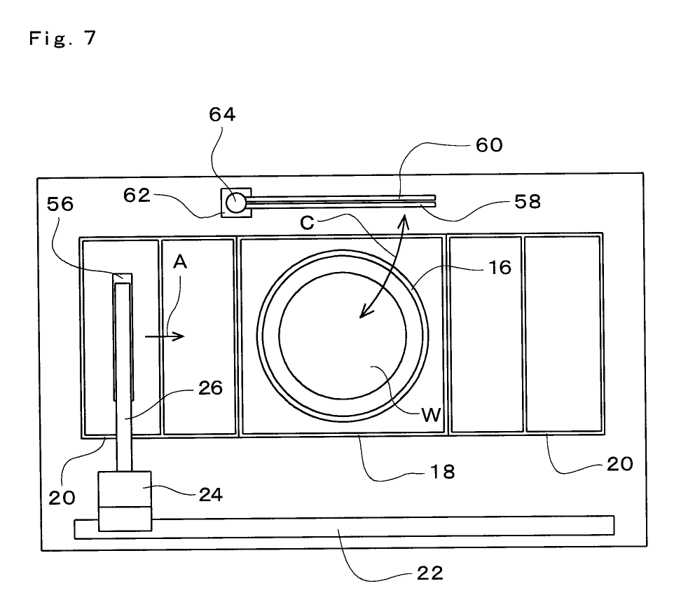

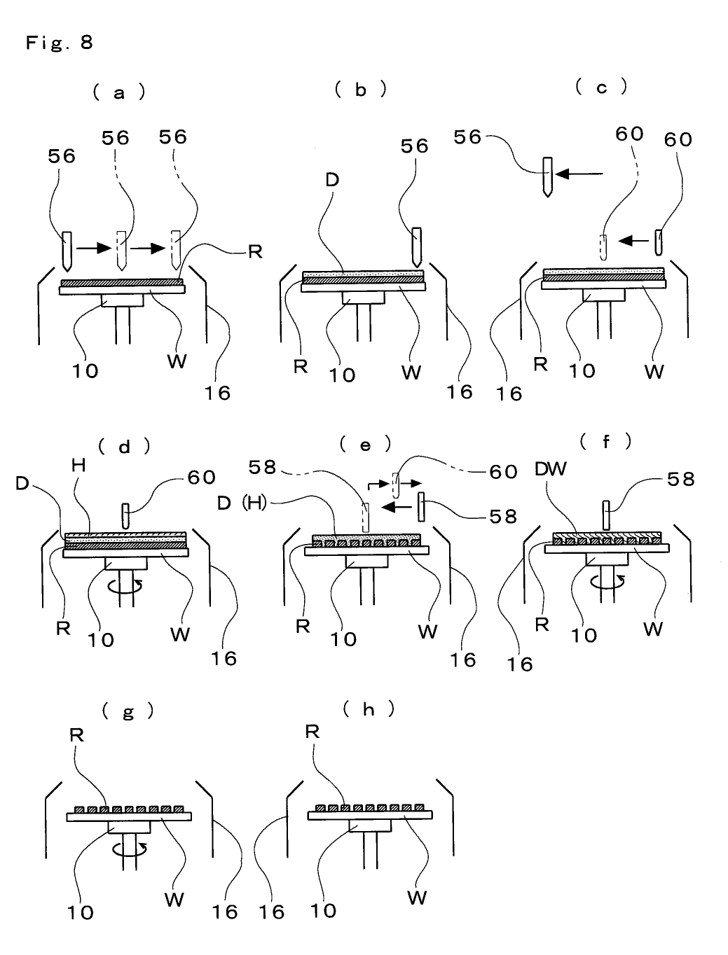

Now, FIG. 7 is a schematic plan view illustrating another example of construction of a processing apparatus for use in carrying out a method of processing a substrate, being a substrate processing method according to this invention. With reference to FIG. 7, each member designated by the same reference numerals as those in FIG. 1 have the same function and action as those of each of the above-mentioned members described with reference to FIG. 1, and thus further description thereof is omitted.

In this processing apparatus, a developer discharge nozzle 56 is connected though a developer feed tube not illustrated to a developer reservoir in which a developer normally used is contained. Accordingly, being different from the processing apparatus illustrated in FIG. 1, any developer mixed with a hydrophobizing agent is not discharged from a slit-like outlet of the developer discharge nozzle 56, but a normal developer is discharged onto the substrate W. Further, there are disposed in the rear-side vicinity of the outside cup 18 a DI water discharge nozzle 58 discharging onto the substrate W a rinsing liquid, for example, a DI water from an outlet at a tip end, and a solution discharge nozzle 60 discharging onto a substrate W a hydrophobic solution containing a hyrophobizing agent from an outlet at a tip end. The DI water discharge nozzle 58 is channel-connected through a DI water feed tube not illustrated to a DI water supply source, and the solution discharge nozzle 60 is channel-connected to a solution reservoir in which a hydrophobic solution containing a hydrophobizing agent is contained. As a hydrophobizing agent, dimethyldichlorosilane, HMDs or a perfluoro compound such as perfluoroalkylether, or an admixture thereof is used. In addition, a hydrophobic solution, as described above, is prepared by adding a hydrophobizing agent to a suitable solvent such as xylene or water. Furthermore, to uniformly mix a hydrophobizing agent with the solvent and water, a small amount of surfactant may be added. The DI water discharge nozzle 58 and the solution discharge nozzle 60 are both held by a nozzle holding portion 64 pivotally supported by a rotational drive section 62. In addition, it is constructed such that by the rotation about a vertical shaft of the nozzle holding portion 64 by means of the rotational drive section 62, the DI water discharge nozzle 58 and the solution discharge nozzle 60 are turned within a horizontal plane in directions indicated by the arrow C.

An example of processing operation with the processing apparatus having the construction illustrated in FIG. 7 is hereinafter described referring to schematic diagrams illustrated in FIG. 8.

As illustrated in FIG. 8(a), when a substrate W on which surface a resist film R having been exposed is formed is carried into the apparatus and the substrate W is held by the spin chuck 10, then as illustrated in FIG. 8(b), while a developer D is being discharged from a slit-like outlet of the developer discharge nozzle 56, the developer discharge nozzle 56 is scanned in a direction indicated by the arrow A (refer to FIG. 7) by means of an arm driving portion 24. In this manner, the developer D is fed onto a substrate W to be evenly spread. When the developer discharge nozzle 56 is moved to a position of the stand-by pot 20 on the right side, the discharge of the developer is stopped, the developer discharge nozzle 56 is moved to a direction opposite to the direction indicated by the arrow A by means of the arm driving portion 24, and the developer discharge nozzle 56 is returned to the original position of the stand-by pot 20 on the left side. Then, the substrate W remains to be still in a state that the developer D is evenly spread over the substrate W, and thus the resist film R on the surface of the substrate W is developed.

Subsequent to the mentioned operation of evenly spreading the developer over the substrate W as illustrated in FIG. 8(c), the solution discharge nozzle 60 (and the DI water discharge nozzle 58) is turned, then as illustrated in FIG. 8(d), a tip end outlet of the solution discharge nozzle 60 is moved to a position right over the center of a substrate W, and a hydrophobic solution H containing a hydrophobizing agent is discharged to the center of the substrate W from the tip end outlet of the solution discharge nozzle 60. The hydrophobic solution H fed onto the substrate W is spread over the entire surface of the substrate W. At this time, it is preferable that the substrate W is rotated at a low speed. Thus, due to that the hydrophobic solution H is fed onto the substrate W, a resist pattern surface newly exposed by the development process is made to be hydrophobic with the hydrophobizing agent. When completing the discharge of the hydrophobic solution, the solution discharge nozzle 60 (and the DI water discharge nozzle 58) is turned and returned to the original position illustrated in FIG. 7.

When passing a predetermined time period since the developer being evenly spread over the substrate W, then as illustrated in FIG. 8(e), the DI water discharge nozzle 58 (and the solution discharge nozzle 60) are turned, and the tip end outlet of the DI water discharge nozzle 58 is moved to a position right over the center of the substrate W as illustrated in FIG. 8(f), and a DI water DW is discharged to the center of the substrate W from the tip end outlet of the DI water discharge nozzle 58. At this time, it is preferable that the substrate W is rotated at a low speed. In this manner, the developing reaction of the resist film R on the surface of a substrate W is stopped, and the developer or dissolved substances are washed away with the DI water DW from the resist film R. When completing the discharge of the DI water, the DI water discharge nozzle 58 (and the solution discharge nozzle 60) is turned and returned to the original position illustrated in FIG. 7. Then, after the DI water has been discharged, as illustrated in FIG. 8(g), the substrate W is rotated, the DI water is splashed away from the substrate W by a centrifugal force to be removed, and the substrate W is spun and dried. During this operation, the inside cup 16 is kept to be elevated. At the time of these rinsing and spin drying, as in the case of conducting a processing with the use of the processing apparatus illustrated in FIGS. 1 to 4, the surface of a resist pattern RP is made to be hydrophobic, and thus a surface tension or a surface free energy of the resist pattern is lowered, so that an energy of liquid being adhered to the surface of the resist pattern is decreased. Therefore, even if there remains any liquid such as developer or DI water in a gap between one pattern and another, a Laplace force of the liquid to be exerted on the pattern is reduced, and thus the collapse of resist pattern is prevented. When drying of the substrate W is ended, as illustrated in FIG. 8(h), the rotation of the substrate W is stopped, and the substrate W is removed from the spin chuck 10 to be carried out of the apparatus.

As described above, in the mentioned processing method of a substrate, after the developer D has been evenly spread over the substrate W and subsequent to this operation of being evenly spread, a hydrophobic solution containing a hydrophobizing agent is fed onto the substrate W from the tip end outlet of the solution discharge nozzle 60, and thus the resist pattern surface is made to be hydrophobic. However, it is also preferable that after the developer D has been evenly spread over the substrate W, the tip end outlet of the DI water discharge nozzle 58 is moved to the position right over the center of a substrate W, and the DI water DW is discharged to the center of the substrate W from the tip end outlet of the DI water discharge nozzle 58, to make a preliminary rinsing of the resist film R; and thereafter, a hydrophobic solution containing a hydrophobizing agent is discharged to the center of the substrate W from the tip end outlet of the solution discharge nozzle 60 to make the resist pattern surface hydrophobic.

Furthermore, in the processing apparatus illustrated in FIG. 7, the solution discharge nozzle 60 discharging a hydrophobic solution containing a hydrophobizing agent onto the substrate W is disposed, and the hydrophobic solution is fed onto the substrate W from the tip end outlet of the solution discharge nozzle 60, whereby the resist pattern surface is made to be hydrophobic with the hydrophobizing agent contained in the hydrophobic solution. However, it is also preferable that a steam jet nozzle is disposed instead of the solution discharge nozzle 60, this steam jet nozzle is channel-connected to a steam supply source of a hydrophobizing agent through a steam feed tube, the steam of a hydrophobizing agent is discharged onto a substrate W from the tip jet port of the steam jet nozzle, and the hydrophobizing agent is made to be in contact with the surface of the resist film in a steam state, thereby making the resist pattern surface hydrophobic.

Furthermore, in the processing apparatus illustrated in FIGS. 1 and 7, to discharge a DI water (rinsing liquid) onto a substrate W to rinse a resist film, the DI water discharge nozzle 52, 58 of a straight nozzle type is to be used. It is preferable, however, to employ a slit nozzle which includes a slit-like outlet at a lower end face, while linearly moving in a direction orthogonal to the slit-like outlet, and which discharges a DI water (rinsing liquid) onto a resist film on a substrate surface from the slit-like outlet, to evenly spread the DI water on the resist film on which a developer is evenly spread.

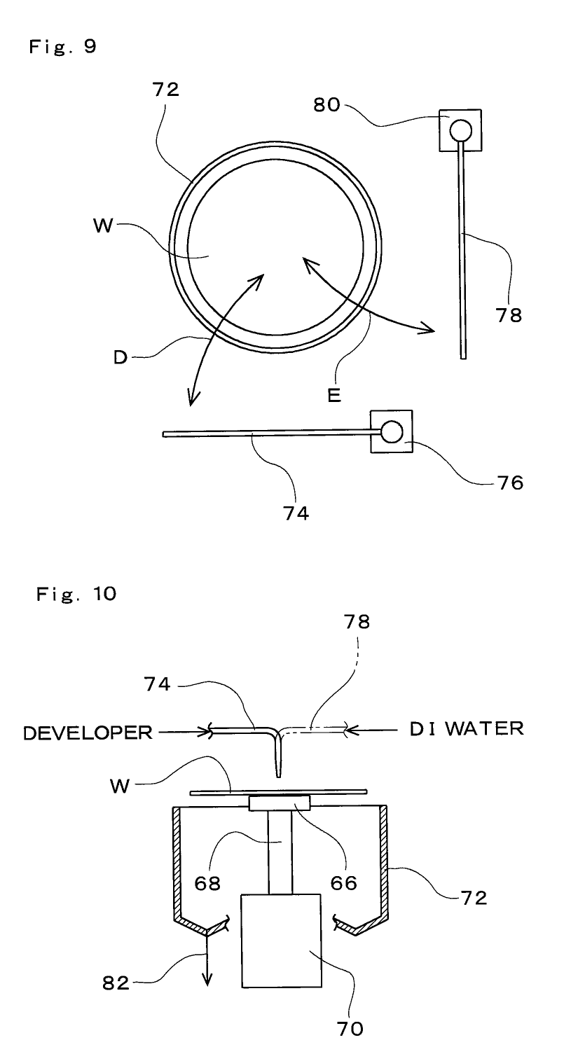

Now, FIGS. 9 and 10 illustrate a further example of construction of a processing apparatus for use in carrying out a method of processing a substrate, being a substrate processing method according to this invention. FIG. 9 is a plan view illustrating a schematic construction of the processing apparatus. FIG. 10 is a schematic longitudinally sectional view thereof.

This processing apparatus, at the central portion of the apparatus where processing of a substrate W is conducted, is provided with a spin chuck 66 holding a substrate W in a horizontal posture, a rotary shaft 68 to which upper end portion the spin chuck 66 is fixed and which is vertically supported, and a rotation motor 70 of which rotary shaft is connected to the rotary shaft 68 and which causes the spin chuck 10 and the rotary shaft 68 to rotate about a vertical axis. A cup 72 of circular shape is disposed around the spin chuck 66 so as to surround the substrate W on the spin chuck 66. This cup 72 is supported by a support mechanism, not illustrated in a reciprocally movable manner in a vertical direction.

Disposed in a front-side vicinity of the cup 72 is a developer discharge nozzle 74 discharging a developer onto a substrate W from an outlet at a tip end. The developer discharge nozzle 74 is held by a nozzle holding portion 76 pivotally in a horizontal plane in directions indicated by an arrow D, and constructed so as to reciprocate between a stand-by position illustrated in FIG. 9 and a discharge position where the outlet at the tip end is located right over the center of a substrate W. Further, with the developer discharge nozzle 74, a predetermined amount of developer is dripped and fed from the tip end outlet to the center of a substrate W rotating at a low speed, and a developer is applied on the entire surface of a resist film having been exposed that is formed on the surface of a substrate W. In addition, disposed in the side vicinity of the cup 72 is a DI water discharge nozzle 78 discharging onto the substrate W a rinsing liquid, for example, a DI water from an outlet at a tip end. The DI water discharge nozzle 78 is channel-connected to a DI supply source through a DI water feed tube not illustrated. The DI water discharge nozzle 78 is held by a nozzle holding portion 80 pivotally in a horizontal plane in directions indicated by the arrow E, and constructed so as to reciprocate between a stand-by position illustrated in FIG. 9 and a discharge position where the outlet at the tip end is located right over the center of the substrate W. Furthermore, with the DI water discharge nozzle 78, the DI water is discharged from the tip end outlet to the center of the substrate W rotating at a low speed, and the resist film on the surface of a substrate W is rinsed. Moreover, a drainage tube 82 is communicated to the bottom of the cup 72.

In the processing apparatus of the above-mentioned construction, there is provided a developer feed system (refer to FIG. 4) feeding a hydrophobic solution containing a hydrophobizing agent to the developer discharge nozzle 74. Further, by conducting a processing, rinsing and spin-drying in the same operation and procedure (refer to FIG. 5) as those of the foregoing processing apparatus illustrated in FIGS. 1 to 4, the collapse of resist pattern can be prevented.

Furthermore, in the processing apparatus constructed as illustrated in FIGS. 9 and 10, a solution discharge nozzle discharging a hydrophobic solution containing a hydrophobizing agent onto the substrate W is additionally disposed, or a steam jet nozzle blowing out a hydrophobizing agent onto the substrate W in a steam state is additionally disposed. Then, by conducting the processing, rinsing and spin-drying in the same operation and procedure (refer to FIG. 8) as those of the mentioned processing apparatus illustrated in FIG. 7, the collapse of resist pattern can be prevented.

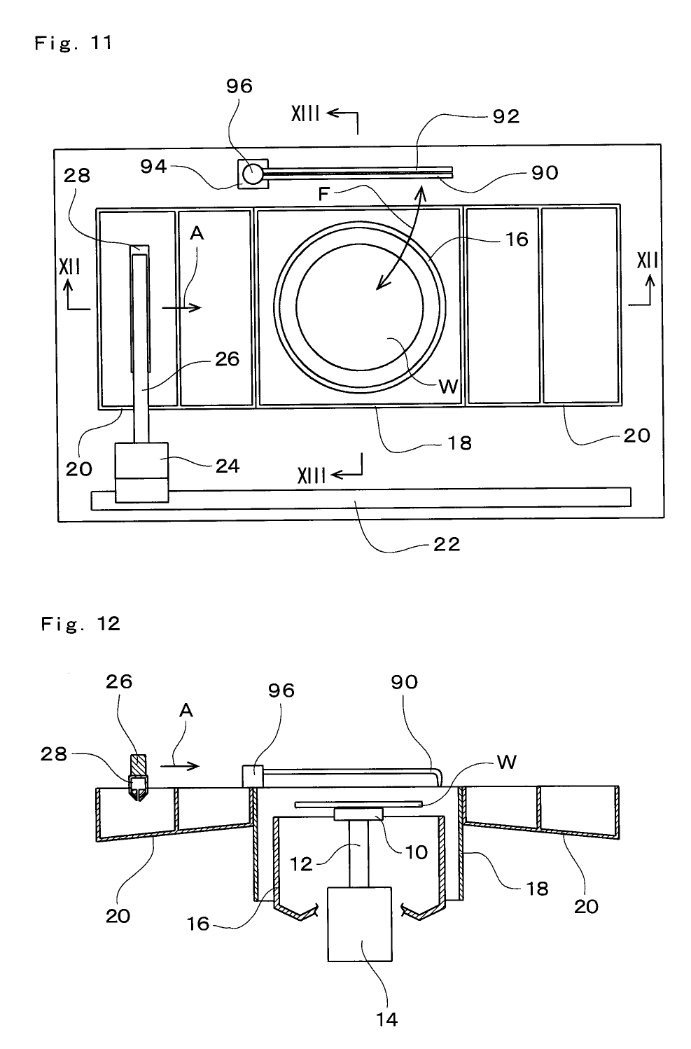

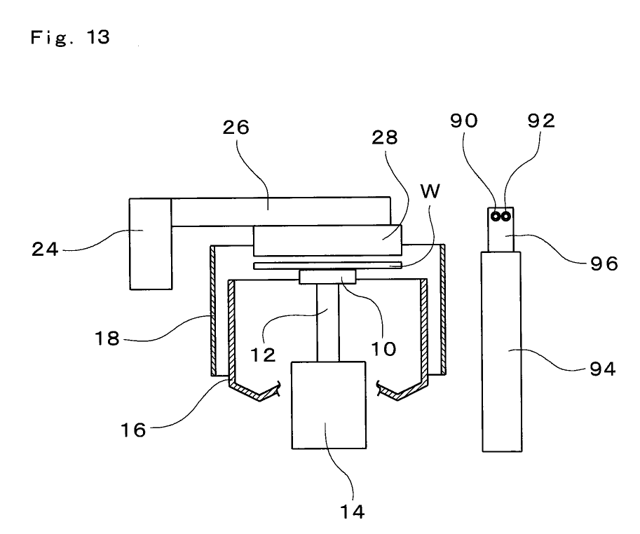

Now, FIGS. 11 to 13 illustrate a still further example of construction of a processing apparatus for use in carrying out a method of processing a substrate, being a substrate processing method according to the invention. FIG. 11 is a plan view illustrating a schematic construction of the processing apparatus. FIG. 12 is a sectional view taken along the line XII-XII of FIG. 11. FIG. 13 is a sectional view taken along the line XIII-XIII of FIG. 11. With reference to these FIGS. 11 through 13, each member designated with the same reference numerals as those used in FIGS. 1 through 3 has the same function and action as those of each of the above-described members described with reference to FIGS. 1 through 3, and further descriptions thereof will be omitted.

In the processing apparatus illustrated in FIGS. 11 through 13, a developer discharge nozzle 28 is channel-connected to a developer reservoir in which a developer is contained through a developer feed tube not illustrated.

There are disposed in the rear-side vicinity of the outside cup 18 a DI water discharge nozzle 90 discharging a rinsing liquid onto a substrate W, for example, a DI water from an outlet at a tip end, and a solvent discharge nozzle 92 discharging a solvent containing a hydrophobic resin onto the substrate W from an outlet at a tip end. The DI water discharge nozzle 90 is channel-connected to a DI water supply source through a DI water feed tube not illustrated, and the solvent discharge nozzle 92 is channel-connected to a solvent reservoir in which a solvent containing a hydrophobic resin is contained. The DI water discharge nozzle 90 and the solvent discharge nozzle 92 are both held by a nozzle holding portion 96 pivotally supported by a rotational drive section 94. Furthermore, it is constructed such that by the nozzle holding portion 96 being turned about a vertical axis by means of the rotational drive section 94, the DI water discharge nozzle 90 and the solvent discharge nozzle 92 are turned within a horizontal plane in directions indicated by the arrow F.

Employed as a hydrophobic resin is the one in which, when a hydrophobic resin film is formed on a resist pattern surface as described below, the hydrophobic resin film forms a contact angle of 70° to 110° with a DI water (rinsing liquid). For example, fluorine-based resins or silicone-based resins are used. Further, as a solvent, the one that is water-insoluble and of which specific gravity is large as compared with a developer is preferably used. The reason of using a non-aqueous solvent, in the case where any solvent containing a hydrophobic reins is fed onto a resist film on a substrate surface after a development process as described below, is to prevent the solvent containing a hydrophobic resin and developer from being dissolved with each other, and thus to prevent the hydrophobic resin from being diffused into a liquid mixture; and to cause the hydrophobic resin to be in contact with a resist pattern surface newly exposed by the development process in the state that the hydrophobic resin is contained in a solvent layer at a high concentration. Furthermore, the reason of using a solvent of which specific gravity is larger than that of a developer is that a solvent containing a hydrophobic resin and a developer are separated in two layers, and thus the solvent containing a hydrophobic resin is laid on the lower layer side, whereby the solvent containing a hydrophobic resin is reliably in contact with the resist pattern surface. As such a solvent, for example, hydrofluoroether is used. One example of articles available on the market to be used as a solvent containing a hydrophobic resin is Novec EGC-1700, EGC-1720 produced by Sumitomo 3M Co., Ltd.

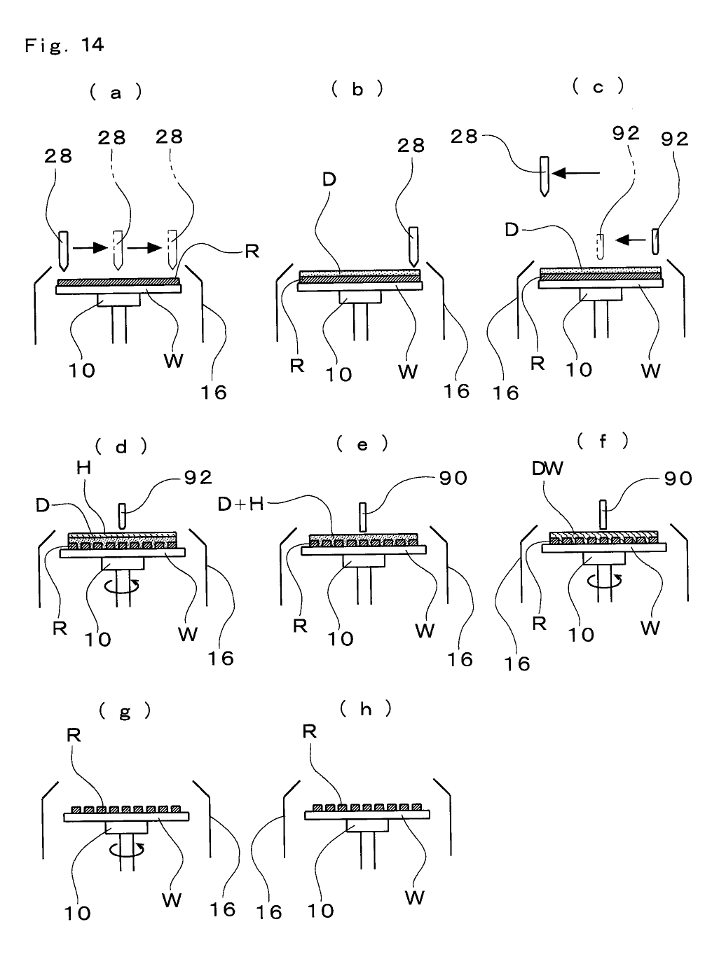

Now, one example of processing operation with the use of a processing apparatus having the above-mentioned construction is described referring to schematic views illustrated in FIGS. 14(a) to (h).

As illustrated in FIG. 14(a), when a substrate W on which surface a resist film R having been exposed is formed is carried into the apparatus and the substrate W is held by the spin chuck 10, the developer discharge nozzle 28 is scanned by the arm driving portion 24 in a direction indicated by the arrow A (refer to FIGS. 11 and 12), while a developer D is being discharged from a slit-like outlet of the developer discharge nozzle 28 as illustrated in FIG. 14(b). Thus, the developer D is evenly spread over the substrate W. When the developer discharge nozzle 28 is moved to a position of the stand-by pot 20 on the right side, the discharge of the developer is stopped, the developer discharge nozzle 28 is moved by means of the arm driving portion 24 in a direction opposite to the direction indicated by the arrow A, and the developer discharge nozzle 28 is returned to an original position of the stand-by pot 20 on the left side. Then, the substrate W remains to be still in the state that the developer D is evenly spread over the substrate W, and the resist film R on the surface of the substrate W is developed.

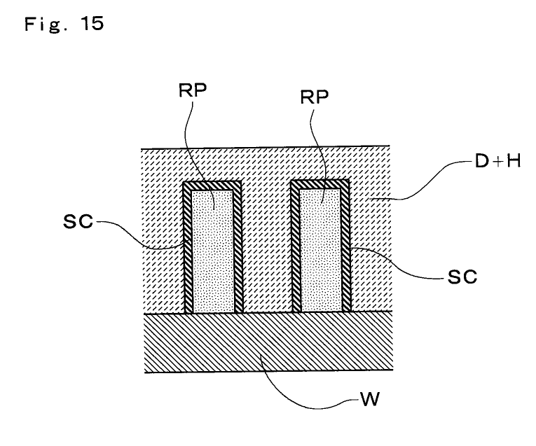

Subsequent to the mentioned operation of the liquid being evenly spread over the substrate W, the solvent discharge nozzle 92 (and the DI water discharge nozzle 90) is turned as illustrated in FIG. 14(c), and a tip end outlet of the solvent discharge nozzle 92 is moved to a position right over the center of the substrate W as illustrated in FIG. 14(d). Then, when a predetermined time period has elapsed since the developer D being evenly spread over the substrate W, a solvent H containing a hydrophobic resin is discharged to the center of the substrate W from the tip end outlet of the solvent discharge nozzle 92. The solvent H containing a hydrophobic resin having been fed onto the substrate W is spread over the entire surface of the substrate W. At this time, it is preferable that the substrate W is rotated at a low speed. Thus, due to that the solvent H containing a hydrophobic resin is fed onto the substrate W, as is illustrated in FIG. 15 being a partially enlarged sectional view, a hydrophobic resin film SC is formed on the surface of a resist pattern RP (resist exposed surface) newly exposed by the development process, and the resist exposed surface is coated with the hydrophobic resin film SC.

Subsequently, as illustrated in FIG. 14(e), in the state that the tip end outlet of the DI water discharge nozzle 90 (and the solvent discharge nozzle 92) is located at the position right over the center of the substrate W, a DI water DW is discharged to the center of the substrate W from the tip end outlet of the DI water discharge nozzle 90 as illustrated in FIG. 14(f). At this time, it is preferable that the substrate W is rotated at a low speed. In this manner, the developer or dissolved substances are washed away from the resist film R with the DI water. The DI water discharge nozzle 90 (and the solvent discharge nozzle), when the discharge of a DI water is ended, is turned and returned to the original position illustrated in FIG. 11. Furthermore, after the discharge of the DI water, as illustrated in FIG. 14(e), the substrate W is rotated, the DI water is splashed away from the substrate W by a centrifugal force to be removed, and the substrate W is dried. During this operation, the inside cup 16 is kept to be elevated. At the time of these rinsing and spin drying, the surface of a resist pattern RP is coated with a hydrophobic resin film SC (refer to FIG. 15), so that a contact angle θ between the resist pattern RP (i.e., the hydrophobic resin film SC) and the DI water is appropriately 90°. Therefore, even if there remains any DI water in a gap between the resist pattern RP and the resist pattern RP, a stress to be exerted on a resist pattern RP caused by a Laplace force of the DI is reduced, so that the collapse of resist pattern RP is prevented. When drying of a substrate W is ended, as illustrated in FIG. 14(h), the rotation of the substrate W is stopped, and the substrate W is removed from the spin chuck 10 to be carried out of the apparatus.

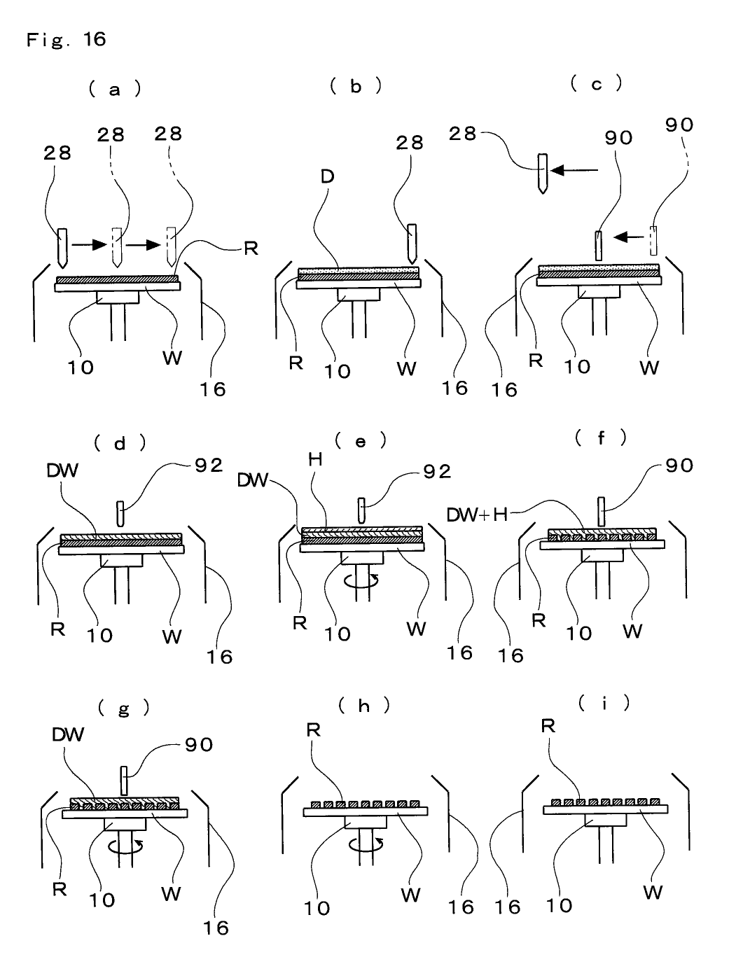

In addition, it is preferable that using the processing apparatus illustrated in FIGS. 11 to 13, after the developer has been evenly spread over the substrate, the resist film is subjected to a preliminary rinsing subsequent to this operation of being evenly spread, and thereafter, a solvent containing a hydrophobic resin is fed onto the resist film. Such a processing operation is now described referring to schematic diagrams illustrated in FIG. 16.

As illustrated in FIGS. 16 (a) and (b), the processing is conducted in the same manner as the above-mentioned processing operations (refer to FIGS. 14(a) and (b)). When a predetermined time period has elapsed since the developer D being evenly spread over the substrate W, the DI water discharge nozzle 90 (and the solvent discharge nozzle 92) is turned as illustrated in FIG. 16(c), the tip end outlet of the DI water discharge nozzle 90 is moved to the position right over the center of the substrate W, and a DI water DW is discharged to the center of the substrate W from the tip end outlet of the DI water discharge nozzle 90. At this time, it is preferable that the substrate W is rotated at a low speed. In this manner, the developing reaction of the resist film R on the surface of the substrate W is stopped, and the developer or dissolved substances are washed away from the resist film R.

Subsequent to the preliminary rinsing, in the state that the tip end outlet of the solvent discharge nozzle 92 (and the DI water discharge nozzle 90) is located at the position right over the center of the substrate W as illustrated in FIG. 16(d), a solvent H containing a hydrophobic resin is discharged to the center of the substrate W from the tip end outlet of the solvent discharge nozzle 92 as illustrated in FIG. 16(e). The solvent H containing a hydrophobic resin having been fed onto the substrate W is spread over the entire surface of the substrate W. At this time, it is preferable that the substrate W is rotated at a low speed. Thus, due to that the solvent H containing a hydrophobic resin is fed onto the substrate W, in the same manner as is the case of the above-described processing operation, a hydrophobic resin film is formed on the surface of a resist pattern newly exposed by the development process, and the resist exposed surface is coated with the hydrophobic resin film. As a hydrophobic resin, employed is the same one as mentioned above; and as the solvent containing a hydrophobic resin, employed is the same one as mentioned above. In the case of using any solvent of which specific gravity is larger than that of the DI water (rinsing liquid), the solvent containing a hydrophobic resin and water are separated in two layers, and the solvent containing a hydrophobic resin is laid on the lower layer side, whereby the solvent containing a hydrophobic resin is reliably in contact with the resist pattern surface. Accordingly, the use of such a solvent is preferred.

Rinsing and spin-drying after the above-mentioned processes are conducted in the same manner as the above-mentioned processing operations, as illustrated in FIGS. 16(f) to 16(i) (refer to FIGS. 14(e) to (h)). During these rinsing and spin-drying, the surface of the resist pattern is coated with a hydrophobic resin film, so that likewise the above-mentioned processing operations, even if there remains any DI water in a gap between one resist pattern and another resist pattern, a stress to be exerted on the resist pattern caused by a Laplace force of the DI water is reduced, thus preventing the collapse of resist pattern.

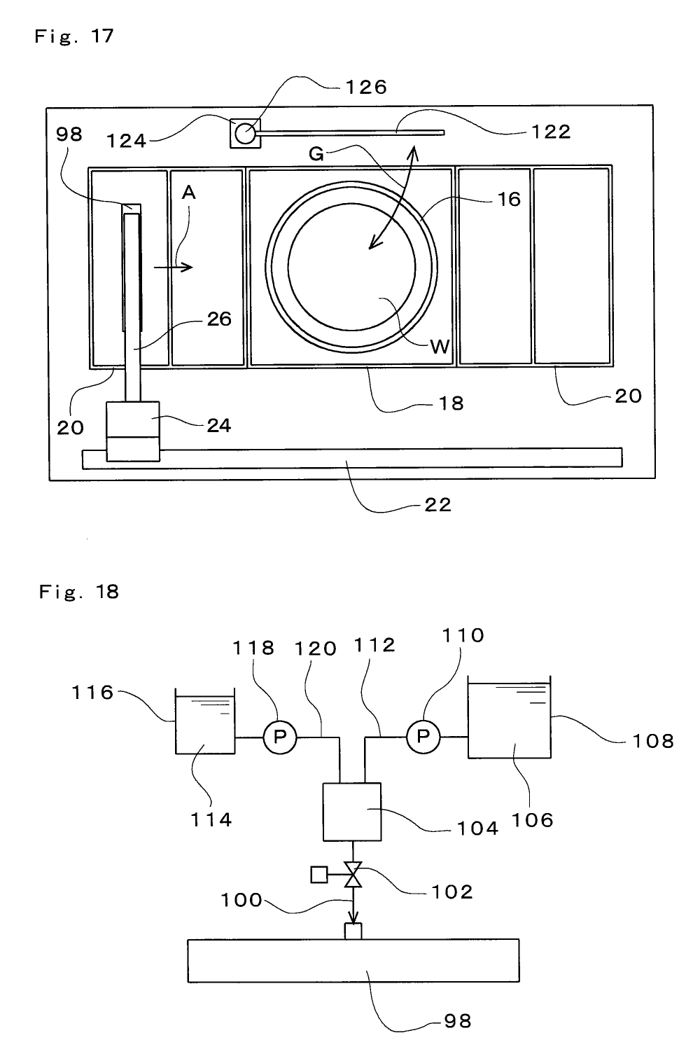

Now, FIGS. 17 and 18 illustrate a still further example of construction of a processing apparatus for use in carrying out a method of processing a substrate, being a substrate processing method according to the present invention. FIG. 17 is a plan view illustrating a schematic construction of a processing apparatus. FIG. 18 is a schematic diagram illustrating a developer supply system of this processing apparatus. With reference to FIG. 17, each member designated with the same reference numerals as those in FIGS. 1 and 11 has the same function and action as those of each of the above-mentioned members described with reference to FIG. 1, and further description thereof is omitted.

In this processing apparatus, a developer feed tube 100 is communicated to a developer discharge nozzle 98, and a switching control valve 102 is interposed in a developer feed tube 100. The developer feed tube 100 is communicated to a liquid mixer 104. A developer feed pipe line 112 which is channel-connected to a developer reservoir 116 containing a developer 106 therein, and in which a pump 110 is interposed, is communicated to the liquid mixer 104. In addition, a solution feed pipe line 120 which is channel-connected to a solvent reservoir 116 in which a solvent 114 containing a hydrophobic resin is contained, and in which a pump 118 is interposed, is communicated to the liquid mixer 104. Further, it is constructed such that a developer to be fed from the developer reservoir 108 through the developer feed pipe line 112 to the liquid mixer 104, is mixed in the liquid mixer 104 with a solvent containing a hydrophobic resin to be fed from the solvent reservoir 116 through the solvent feed pipe line 120 to the liquid mixer 104, then the developer mixed with the solvent containing a hydrophobic resin is fed from the liquid mixer 104 through the developer feed tube 100 to the developer discharge nozzle 98. In the same manner as is the case of the processing apparatus illustrated in FIGS. 11 through 13, as a hydrophobic resin, employed is the one in which a hydrophobic resin film forms a contact angle of 70° to 110° with a DI water (rinsing liquid) when this hydrophobic resin film is formed on the resist pattern surface. For example, fluorine-based resins or silicone-based resins are used. Furthermore, as a solvent, the one that is water-insoluble is preferably used, as well as the one of which specific gravity is large as compared with a developer is preferably used.

Disposed in the rear-side vicinity of the outside cup 18 is a DI water discharge nozzle 122 discharging a rinsing liquid, for example, a DI water to the center of the substrate W from an outlet at a tip end. The DI water discharge nozzle 122 is channel-connected to a DI water supply source through a DI water feed tube not illustrated. The DI water discharge nozzle 122 is held by a nozzle holding portion 126 pivotally supported by means of a rotational drive section 124. Furthermore, it is constructed such that, by the nozzle holding portion 126 being turned about a vertical axis by means of the rotational drive section 124, the DI water discharge nozzle 122 is turned within a horizontal plane in directions indicated by the arrow G, and reciprocated between a stand-by position illustrated in FIG. 17 and a discharge position where the outlet at the tip end is located right over the center of the substrate W.

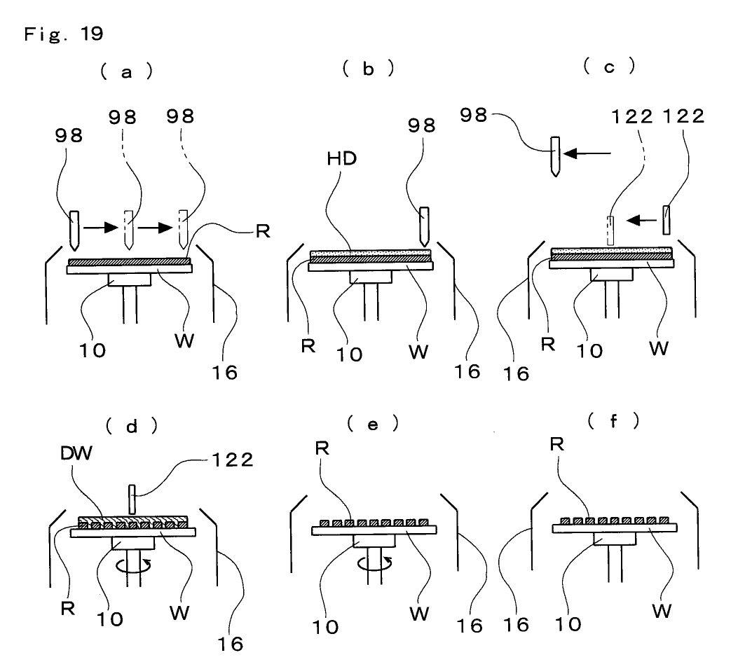

One example of a processing operation with the processing apparatus illustrated in FIG. 17 is described referring to schematic diagrams illustrated in FIG. 19.

When a substrate W on which surface a resist film R having been exposed is formed is carried into the apparatus and the substrate W is held on the spin chuck 10 as illustrated in FIG. 19(a), the developer discharge nozzle 98 is scanned in a direction indicated by an arrow A (refer to FIG. 17) by means of the arm driving portion 24, while a developer HD mixed with a solvent containing a hydrophobic resin is being discharged from a slit-like outlet of the developer discharge nozzle 98, as illustrated in FIG. 19(b). Thus, the developer HD is evenly spread over the substrate W. When the developer discharge nozzle 98 is moved to a position of the stand-b pot 20 on the right side, the discharge of the developer is stopped, the developer discharge nozzle 98 is moved by means of the arm driving portion 24 in a direction opposite to the direction indicated by the arrow A, and the developer discharge nozzle 98 is returned to the original position of the stand-by pot 20 on the left side. The substrate W is left still until a predetermined time period has elapsed since the developer HD being evenly spread over the substrate W, and then the resist film R on the surface of the substrate W is developed. At this time, due to that the developer HD having been fed onto the substrate W is mixed with a solvent containing a hydrophobic resin, so that in the same manner as the case of processing with the use of the processing apparatus illustrated in FIGS. 11 through 13, a hydrophobic resin film is formed on the surface (resist exposed surface) of a resist pattern newly exposed by the development process, and the resist exposed surface is coated with the hydrophobic resin film.

When a predetermined time period has elapsed since the liquid being evenly spread over a substrate W, the DI water discharge nozzle 122 is turned as illustrated in FIG. 19(c), a tip end outlet of the DI water discharge nozzle 122 is moved to the position right over the center of the substrate W as illustrated in FIG. 19(d), and the DI water DW is discharged to the center of the substrate W from the tip end outlet of the DI water discharge nozzle 122. At this time, it is preferable that the substrate W is rotated at a low speed. Thus, the developing reaction of the resist film R on the surface of the substrate W is stopped, and the developer, dissolved substances, solvent or the like are washed away from the resist film R with the DI water DW. The DI water discharge nozzle 122, when the discharge of the DI water is ended, is turned and returned to the original position illustrated in FIG. 17. Then, after the DI water has been discharged, as illustrated in FIG. 19(e), a substrate W is rotated, the DI water is splashed away from the substrate W by a centrifugal force to be removed, and the substrate W is dried by spinning. During this operation, the inside cup is kept to be elevated. At the time of these rinsing and spin drying, in the same manner as is the case of processing with the use of the processing apparatus illustrated in FIGS. 11 through 13, the surface of the resist pattern is coated with a hydrophobic resin film, so that a contact angle θ between the resist pattern (i.e., the hydrophobic resin film) and the DI water is approximately 90°. Therefore, even if there remains any DI water in a gap between one resist pattern and another, a stress to be exerted on the resist pattern caused by a Laplace force of the DI water is decreased, so that the collapse of resist pattern is prevented. When ending the drying of the substrate W, as illustrated in FIG. 19(f), the rotation of the substrate W is stopped, and the substrate W is removed from the spin chuck 10 to be carried out of the apparatus.

Additionally, in the processing apparatus illustrated in FIGS. 11 to 17 and FIG. 17, to discharge the DI water (rinsing liquid) onto the substrate W to conduct the rinsing of the resist film, the DI water discharge nozzle 90, 62 of straight nozzle type is to be used. It is preferable, however, to employ a slit nozzle which includes a slit-like discharge nozzle at a lower end face, and which discharges the DI water (rinsing liquid) on the resist film on the substrate surface from the slit-like outlet while linearly moving in a direction orthogonal to the slit-like outlet, to evenly spread the DI water on the resist film on which the developer is evenly spread.

Now, in the processing apparatus of the construction illustrated in FIGS. 9 and 10, it is preferable that there is provided a developer supply system (refer to FIG. 18) feeding a solvent containing a hydrophobic resin to the developer discharge nozzle 74. Then, by conducting a rinsing and spin drying in the same operation and procedure (refer to FIG. 19) as those of the processing apparatus illustrated in FIG. 17, the collapse of resist pattern can be prevented.

Further, in the processing apparatus of construction illustrated in FIGS. 9 and 10, it is preferable that a solvent discharge nozzle discharging onto the substrate W a solvent containing a hydrophobic resin is additionally disposed. Then, by conducting a processing, rinsing and spin drying in the same operation and procedure (refer to FIGS. 14 and 16) as those of the processing apparatus illustrated in FIGS. 11 through 13, the collapse of resist pattern can be prevented.

Additionally, in the case where a substrate is dried by spinning after rinsing, when the so-called scan rinsing is applied to dry the substrate, that is, when the substrate is held in a horizontal posture and rotated about the vertical axis, and the outlet of the DI water discharge nozzle is scanned from a position opposed to the center of the substrate to a position opposed to the circumferential edge of the substrate, while the DI water (rinsing liquid) is being discharged onto the surface of the substrate from the outlet of the DI water (rinsing liquid) discharge nozzle, to dry the substrate, the collapse of resist pattern can be effectively prevented by carrying out the method according to the invention.

Moreover, according to the above-described embodiment, in the case where a substrate is rinsed and dried by spinning after having been processed, a processing method is described, and in which a solvent containing a hydrophobic resin is fed onto a resist film formed on a substrate surface, and a resist pattern surface having newly been exposed by the processing is coated with a hydrophobic resin film. The invention can be preferably applied also to the case where a substrate on which surface a resist film of a predetermined pattern has been already formed is cleaned with chemicals or the like, and thereafter, rinsed and dried by spinning. Specifically, a cleaning solution is fed onto a resist film of a predetermined pattern that is formed on a substrate surface to clean the resist film, thereafter, a rinsing liquid is fed onto the resist film to make a preliminary rinsing, and subsequently, a solvent containing a hydrophobic rein film is fed onto the resist film to form a hydrophobic resin film on the resist pattern surface. In this manner, due to that the resist pattern surface is coated with a hydrophobic resin film, when a substrate is rinsed and dried by spinning thereafter, even if there remains any rinsing liquid in a gap between one resist pattern and another, a stress to be exerted on the resist pattern caused by a Laplace force of the rinsing liquid is reduced, so that the collapse of resist pattern can be prevented.

In each of the above-mentioned embodiments, described is a slit scan method in which a developer discharge nozzle is scanned while a developer is being discharged from a slit-like outlet of the developer discharge nozzle, and thus the developers is evenly spread on the resist film on a substrate surface; or a development method in which a developer is fed to a surface center of a substrate from a developer discharge nozzle (straight nozzle) and the substrate is rotated, thus the developer is evenly spread over the entire surface of the substrate. However, the substrate processing method according to the invention is not particularly limited thereto, but the invention is widely applicable to any other processing method including a method in which a developer is discharged onto a resist film of a substrate surface from a spray nozzle while rotating the substrate.

What is claimed is:

1. A substrate processing method comprising:
a development process in which a developer is fed onto a resist film having been exposed and formed on a surface of a substrate to process the resist film;
a rinsing process in which a rinsing liquid is fed onto the resist film having been processed and formed on the substrate surface to make a rinsing; and
a drying process in which the substrate is rotated about a vertical axis in a horizontal posture to dry the resist film having been rinsed and formed on the substrate surface;
wherein before said rinsing process, a resist exposed surface is made to be hydrophobic.

2. The substrate processing method according to claim 1, wherein in said development process, a developer mixed with a hydrophobizing agent is fed onto the resist film on the substrate surface.

3. The substrate processing method according to claim 1, wherein after said development process, before said rinsing process, a hydrophobizing agent is fed onto the resist film formed on the substrate surface.

4. The substrate processing method according to claim 1, wherein after said development process, before said rinsing process, a rinsing liquid is fed onto the resist film formed on the substrate surface to make a preliminary rinsing, and thereafter, a hydrophobizing agent is fed onto the resist film.

5. The substrate processing method according to claim 3 or 4, wherein said hydrophobizing agent is fed onto the resist film as a hydrophobic solution containing a hydrophobizing agent.

6. The substrate processing method according to claim 5, wherein a surfactant is added to said hydrophobic solution.

7. The substrate processing method according to claim 5, wherein said hydrophobic solution is prepared by adding a surfactant to a hydrophobizing agent of which specific gravity is large as compared with the developer.

8. The substrate processing method according to claim 3 or 4, wherein said hydrophobizing agent is fed onto the resist film in a steam state.

9. The substrate processing method according to any one of claims 2 through 4, wherein dimethyldichlorosilane, hexamethyldisilazane or a perfluoro compound is used as said hydrophobizing agent.

10. The substrate processing method according to claim 1, wherein after said development process, before said rinsing process, a solvent containing a hydrophobic resin is fed onto the resist film having been processed and formed on the substrate surface, and thus the resist exposed surface is coated with a hydrophobic resin film.

11. The substrate processing method according to claim 1, wherein in said development process, a developer mixed with a solvent containing a hydrophobic resin is fed onto the resist film having been exposed and formed on the substrate surface, and thus, the resist exposed surface is coated with a hydrophobic resin film.

12. The substrate processing method according to claim 10 or 11, wherein as a solvent containing said hydrophobic resin, the one of which specific gravity is large as compared with a developer is used.

13. The substrate processing method according to claim 1, wherein after said development process, before said rinsing process, a rinsing liquid is fed onto the resist film having been processed and formed on the substrate surface to make a preliminary rinsing, thereafter a solvent containing a hydrophobic resin is fed onto the resist film, and thus the resist exposed surface is coated with a hydrophobic resin film.

14. The substrate processing method according to claim 1, wherein before said rinsing process, there is included a cleaning process in which a cleaning solution is fed onto the resist film having a predetermined pattern that is formed on the surface of a substrate to make a cleaning of the resist film; and in said rinsing process, a rinsing liquid is fed onto the resist film having been cleaned to make a rinsing; and
after said cleaning process, before said rinsing process, a rinsing liquid is fed onto the resist film having been cleaned and formed on the substrate surface to make a preliminary rinsing, thereafter a solvent containing a hydrophobic resin is fed onto the resist film, and thus the resist exposed surface is coated with a hydrophobic resin film.

15. The substrate processing method according to claim 13 or 14, wherein as a solvent containing said hydrophobic resin, the one of which specific gravity is large as compared with a rinsing liquid is used.

16. The substrate processing method according to claim 10 or 11, or claim 13 or 14, wherein as a solvent containing said hydrophobic resin, the one that is water insoluble is used.

17. The substrate processing method according to claim 10 or 11, or claim 13 or 14, wherein as said hydrophobic resin, the one that makes a contact angle of 70° to 110° between the hydrophobic resin film and the rinsing liquid is used.

18. The substrate processing method according to claim 10 or 11, or claim 13 or 14, wherein said hydrophobic resin is a fluorine-based resin or a silicone-based resin.

19. The substrate processing method according to claim 10 or 11, or claim 13 or 14, wherein in said drying process, a substrate is held in a horizontal posture and rotated about a vertical axis, and while a rinsing liquid is being discharged onto the surface of the substrate from an outlet of a discharge nozzle, said outlet of the discharge nozzle is scanned from a position opposed to the center of the substrate to a position opposed to the circumferential edge of the substrate.

20. A substrate processing apparatus comprising:
substrate holding means holding a substrate in a horizontal posture;
a developer discharge nozzle discharging a developer on a resist film having been exposed and formed on a surface of the substrate held by said substrate holding means;
developer feeding means feeding a developer to said developer discharge nozzle;
a rinsing liquid discharge nozzle discharging a rinsing liquid onto a resist film having been processed and formed on the substrate surface;
rinsing liquid feeding means feeding a rinsing liquid to said rinsing liquid discharge nozzle; and
substrate rotating means rotating the substrate held by said substrate holding means about a vertical axis;
wherein there is provided means for making hydrophobic a resist exposed surface of the resist film before rinsing that is formed on the surface of the substrate.

21. The substrate processing apparatus according to claim 20, wherein said developer feeding means feeding a developer mixed with a hydrophobizing agent to said developer discharge nozzle.

22. The substrate processing apparatus according to claim 20, wherein there are further provided a solution discharge nozzle discharging a hydrophobic solution containing a hydrophobizing agent onto the resist film having been processed and formed on the substrate surface; and
solution feeding means feeding the hydrophobic solution containing a hydrophobizing agent to said solution discharge nozzle.

23. The substrate processing apparatus according to claim 20, wherein there are further provided a steam jet nozzle blowing out a steam of a hydrophobizing agent onto the resist film having been processed and formed on the substrate surface; and
steam feeding means feeding the steam of a hydrophobizing agent to said steam jet nozzle.

24. The substrate processing apparatus according to any one of claims 21 through 23, wherein said developer discharge nozzle is a slit nozzle that includes a slit-like outlet at a lower end face, the developer is discharged onto the resist film on the substrate surface from said slit-like outlet, while linearly moving in a direction orthogonal to said slit-like outlet with respect to a substrate held in a still state by said substrate holding means, and thus the developer is spread forming a continuous film on the entire surface of the resist film.

25. The substrate processing apparatus according to any one of claims 21 through 23, wherein said developer discharge nozzle is a straight nozzle in which the developer is discharged from a tip end outlet to a center of the substrate that is held by said substrate holding means and rotated at a low speed by said substrate rotating means, and thus the developer is spread on the entire surface of the resist film on the substrate surface to apply the developer.

26. The substrate processing apparatus according to claim 20, wherein there are further provided solvent discharge means discharging a solvent containing a hydrophobic resin on the resist film having been processed and formed on the substrate surface; and
solvent feeding means feeding the solvent containing a hydrophobic resin to said solvent discharge means.

27. The substrate processing apparatus according to claim 20, wherein said developer feeding means feeds to said developer discharge nozzle a developer mixed with the solvent containing a hydrophobic resin.

28. The substrate processing apparatus according to claim 26 or 27, wherein said developer discharge nozzle is a slit nozzle that includes a slit-like outlet at a lower end face, the developer is discharged onto the resist film on the substrate surface from said slit-like outlet while linearly moving in a direction orthogonal to said slit-like outlet with respect to a substrate held in a still state by said substrate holding means, and thus the developer is spread forming a continuous film on the entire surface of the resist film.

29. The substrate processing apparatus according to claim 26 or 27, wherein said developer discharge nozzle is a straight nozzle in which the developer is discharged from a tip end outlet to a center of the substrate that is held by said substrate holding means and rotated at a low speed by said substrate rotating means, and thus the developer is spread on the entire surface of the resist film on the substrate surface to apply the developer.

30. The substrate processing apparatus according to claim 20, wherein there are further provided a cleaning solution discharge nozzle discharging a cleaning solution on the resist film having a predetermined pattern that is formed on the surface of the substrate held by said substrate holding means;
cleaning solution feeding means feeding a cleaning solution to said cleaning solution discharge nozzle;
solvent discharge means discharging a solvent containing a hydrophobizing agent on the resist film having been cleaned and formed on the substrate surface; and
solvent feeding means feeding a solvent containing a hydrophobic resin to said solvent discharge means.
